(19) United States
(12) Patent Application Publication
(10) Pub. No.: US 2025/0285588 A1
(43) Pub. Date: Sep. 11, 2025

(54) LUMINANCE COMPENSATION METHOD AND APPARATUS FOR DISPLAY PANEL, AND DISPLAY APPARATUS

(71) Applicants: Hefei Visionox Technology Co., Ltd., Hefei (CN); Visionox Technology Inc., Kunshan (CN)

(72) Inventors: Wenquan CHU, Hefei (CN); Nannan CHEN, Hefei (CN); Fengzhang HU, Hefei (CN); Xinquan CHEN, Kunshan (CN); Can MEI, Hefei (CN)

(73) Assignees: Hefei Visionox Technology Co., Ltd., Hefei (CN); Visionox Technology Inc., Kunshan (CN)

(21) Appl. No.: 19/216,593

(22) Filed: May 22, 2025

(30) Foreign Application Priority Data
Jun. 7, 2024 (CN) 202410744025.6

(51) Int. Cl. G09G 3/3208

(52) U.S. Cl. CPC G09G 3/3208; G09G 2320/0233; G09G 2320/0247

(57) ABSTRACT

The present disclosure discloses a luminance compensation method and apparatus for a display panel, and a display apparatus. The method includes: obtaining a first luminance compensation value based on an instruction to change the luminance adjustment mode; compensating luminances of the first i frames of display images in a current luminance adjustment mode to a target luminance based on the first luminance compensation value, where i is an integer greater than or equal to 1; obtaining a second luminance compensation value when the first i frames in the current luminance adjustment mode end; and compensating luminances of (i+1)^{th} to (i+n)^{th} frames of display images in the current luminance adjustment mode to the target luminance based on the second luminance compensation value, where n is an integer greater than 1, and the (i+n)^{th} frame of display image is the last frame of display image in the current luminance adjustment mode.

### CROSS-REFERENCE TO RELATED APPLICATIONS

The present application claims priority to Chinese Patent Application No. 202410744025.6, filed on Jun. 7, 2024 and entitled “LUMINANCE COMPENSATION METHOD AND APPARATUS FOR DISPLAY PANEL, AND DISPLAY APPARATUS”, which is incorporated herein by reference in its entirety.

### FIELD

Embodiments of the present disclosure relate to the field of display technologies, and in particular, to a luminance compensation method and apparatus for a display panel, and a display apparatus.

### BACKGROUND

A visible flicker phenomenon occurs during the display of a display panel, which reduces the display effect of the display panel and brings poor user experience.

### SUMMARY

The present disclosure provides a luminance compensation method and apparatus for a display panel, and a display apparatus to improve the display effect of the display panel.

According to a first aspect, an embodiment of the present disclosure provides a luminance compensation method for a display panel. A luminance adjustment mode of the display panel includes a pulse width modulation mode. The luminance compensation method for the display panel includes:
obtaining a first luminance compensation value based on an instruction to change the luminance adjustment mode;
compensating luminances of the first i frames of display images in a current luminance adjustment mode to a target luminance based on the first luminance compensation value, where i is an integer greater than or equal to 1;
obtaining a second luminance compensation value when the first i frames in the current luminance adjustment mode end; and
compensating luminances of (i+1)^{th} to (i+n)^{th} frames of display images in the current luminance adjustment mode to the target luminance based on the second luminance compensation value, where n is an integer greater than 1, and the (i+n)^{th} frame of display image is the last frame of display image in the current luminance adjustment mode.

In one embodiment, a display mode of the display panel includes a local high-brightness mode. The luminance compensation method for the display panel further includes:
obtaining, when the display mode of the display panel enters or exits the local high-brightness mode, the instruction to change the luminance adjustment mode.

In one embodiment, the first luminance compensation value includes a first entry luminance compensation value when the display mode of the display panel enters the local high-brightness mode. The compensating luminances of the first i frames of display images in a current luminance adjustment mode to a target luminance based on the first luminance compensation value includes:
decreasing the luminances of the first i frames of display images in the current luminance adjustment mode to the target luminance based on the first entry luminance compensation value.

In one embodiment, the current luminance adjustment mode is the local high-brightness mode.

In one embodiment, i is less than or equal to 5.

In one embodiment, i is less than or equal to 3.

In one embodiment, i is equal to 1.

In one embodiment, the first luminance compensation value includes a first exit luminance compensation value when the display mode of the display panel exits the local high-brightness mode. The compensating luminances of the first i frames of display images in a current luminance adjustment mode to a target luminance based on the first luminance compensation value includes:
increasing the luminances of the first i frames of display images in the current luminance adjustment mode to the target luminance based on the first exit luminance compensation value.

In one embodiment, the current luminance adjustment mode is a normal display mode.

In one embodiment, i is less than or equal to 5.

In one embodiment, i is less than or equal to 3.

In one embodiment, i is equal to 1.

In one embodiment, a number of frames of display images with luminances compensated based on the first luminance compensation value when the display mode of the display panel enters the local high-brightness mode is the same as a number of frames of display images with luminances compensated based on the first luminance compensation value when the display mode of the display panel exits the local high-brightness mode.

In one embodiment, the luminance adjustment mode further includes a voltage modulation mode. The luminance compensation method for the display panel further includes:

obtaining, when the voltage modulation mode and the pulse width modulation mode are switched to each other, the instruction to change the luminance adjustment mode.

In one embodiment, when the luminance adjustment mode is switched from the voltage modulation mode to the pulse width modulation mode, the first luminance compensation value includes a first switching luminance compensation value. The compensating luminances of the first i frames of display images in a current luminance adjustment mode to a target luminance based on the first luminance compensation value includes:

increasing the luminances of the first i frames of display images in the current luminance adjustment mode to the target luminance based on the first switching luminance compensation value.

In one embodiment, the current luminance adjustment mode is the pulse width modulation mode.

In one embodiment, i is less than or equal to 5.

In one embodiment, i is less than or equal to 3.

In one embodiment, i is equal to 1.

In one embodiment, when the luminance adjustment mode is switched from the pulse width modulation mode to the voltage modulation mode, the first luminance compensation value includes a second switching luminance compensation value. The compensating luminances of the first i frames of display images in a current luminance adjustment mode to a target luminance based on the first luminance compensation value includes:

decreasing the luminances of the first i frames of display images in the current luminance adjustment mode to the target luminance based on the second switching luminance compensation value.

In one embodiment, the current luminance adjustment mode is the voltage modulation mode.

In one embodiment, i is less than or equal to 5.

In one embodiment, i is less than or equal to 3.

In one embodiment, i is equal to 1.

In one embodiment, a number of frames of display images with luminances compensated based on the first luminance compensation value when the luminance adjustment mode is switched from the voltage modulation mode to the pulse width modulation mode is the same as a number of frames of display images with luminances compensated based on the first luminance compensation value when the luminance adjustment mode is switched from the pulse width modulation mode to the voltage modulation mode.

In one embodiment, the compensating luminances of the first i frames of display images in a current luminance adjustment mode to a target luminance based on the first luminance compensation value includes:
compensating the luminances of the first i frames of display images in the current luminance adjustment mode to a first luminance based on the first luminance compensation value; and
determining, when a difference between the first luminance and the target luminance is less than a first threshold, that the first luminance is the target luminance.

In one embodiment, after the compensating the luminances of the first i frames of display images in the current luminance adjustment mode to a first luminance based on the first luminance compensation value, the method further includes:

adjusting the first luminance compensation value when the difference between the first luminance and the target luminance is greater than or equal to the first threshold.

In one embodiment, the adjusting the first luminance compensation value when the difference between the first luminance and the target luminance is greater than or equal to the first threshold includes:
adjusting the first luminance compensation value when the first luminance is greater than the target luminance, so as to decrease the first luminance; and
adjusting the first luminance compensation value when the first luminance is less than the target luminance, so as to increase the first luminance.

In one embodiment, compensating the luminances of the display images to the target luminance based on the first luminance compensation value or the second luminance compensation value includes:
determining a gamma value based on a luminance compensation value, where the luminance compensation value includes the first luminance compensation value or the second luminance compensation value;
determining a data voltage based on the gamma value; and
driving, based on the data voltage, the display panel to display the display images.

In one embodiment, obtaining the first luminance compensation value and the second luminance compensation value includes:
obtaining the first luminance compensation value and the second luminance compensation value by using a table lookup method.

In one embodiment, before the obtaining a first luminance compensation value based on an instruction to change the luminance adjustment mode, the method further includes:
determining the first luminance compensation value based on at least one gray level and at least one display luminance level.

In one embodiment, the determining the first luminance compensation value based on at least one gray level and at least one display luminance level includes:

determining the first luminance compensation value based on the gray level, the display luminance level, and a refresh frequency.

In one embodiment, before the obtaining a first luminance compensation value based on an instruction to change the luminance adjustment mode, the method further includes:
determining the second luminance compensation value based on a refresh frequency, at least one gray level, and at least one display luminance level.

According to a second aspect, an embodiment of the present disclosure further provides a luminance compensation apparatus for a display panel. A luminance adjustment mode of the display panel includes a pulse width modulation mode. The luminance compensation apparatus for the display panel includes:
a first luminance compensation value obtaining module configured to obtain a first luminance compensation value based on an instruction to change the luminance adjustment mode;
a first compensation module configured to compensate luminances of the first i frames of display images in a current luminance adjustment mode to a target luminance based on the first luminance compensation value, where i is an integer greater than or equal to 1; a second luminance compensation value obtaining module configured to obtain a second luminance compensation value when the first i frames in the current luminance adjustment mode end; and
a second compensation module configured to compensate luminances of (i+1)^{th} to (i+n)^{th} frames of display images in the current luminance adjustment mode to the target luminance based on the second luminance compensation value, where n is an integer greater than 1, and the (i+n)^{th} frame of display image is the last frame of display image in the current luminance adjustment mode.

In one embodiment, the luminance compensation apparatus for the display panel further includes:
a first luminance compensation value determining module configured to determine the first luminance compensation value based on at least one gray level and at least one display luminance level.

According to a third aspect, an embodiment of the present disclosure further provides a display apparatus, including a display panel and the luminance compensation apparatus for the display panel described in the second aspect. The luminance compensation apparatus for the display panel is connected to the display panel, and is configured to compensate at least one luminance of at least one display image of the display panel in the current luminance adjustment mode to the target luminance based on the instruction to change the luminance adjustment mode.

In the embodiments of the present disclosure, the first luminance compensation value is set additionally, and the first luminance compensation value is obtained based on the instruction to change the luminance adjustment mode. The luminances of the first i frames of display panels in the current luminance adjustment mode are compensated, thereby alleviating the flicker phenomenon of the display panel and improving the display effect of the display panel. In addition, the luminances of the (i+1)^{th} to (i+n)^{th} frames of display panels in the current luminance adjustment mode can be compensated by using the second luminance compensation value for the display panel, thereby ensuring brightness uniformity of the display panel, reducing the additionally set luminance compensation value, lowering the performance requirement on a drive chip of the display panel, and reducing the costs of the display panel.

### BRIEF DESCRIPTION OF THE DRAWINGS

FIG. 1 is a schematic diagram of a display luminance of a display panel in the prior art;

FIG. 2 is a flowchart of a luminance compensation method for a display panel according to an embodiment of the present disclosure;

FIG. 3 is a flowchart of another luminance compensation method for a display panel according to an embodiment of the present disclosure;

FIG. 4 is a schematic diagram of luminances where a luminance adjustment mode of a display panel changes according to an embodiment of the present disclosure;

FIG. 5 is a schematic diagram of simulation of data voltages when a display panel enters a local high-brightness mode in the prior art;

FIG. 6 is a schematic diagram of simulation of data voltages when a display panel enters a local high-brightness mode according to an embodiment of the present disclosure;

FIG. 7 is a schematic diagram of luminances when luminances of the first i frames of display images are compensated by using a first luminance compensation value when a display panel enters a local high-brightness mode according to an embodiment of the present disclosure;

FIG. 8 is a schematic diagram of luminances when luminances of the first i frames of display images are compensated a plurality of times when a display panel enters a local high-brightness mode according to an embodiment of the present disclosure;

FIG. 9 is a flowchart of another luminance compensation method for a display panel according to an embodiment of the present disclosure;

FIG. 10 is a schematic diagram of simulation of data voltages when a display panel exits a local high-brightness mode in the prior art;

FIG. 11 is a schematic diagram of simulation of data voltages when a display panel exits a local high-brightness mode according to an embodiment of the present disclosure;

FIG. 12 is a schematic diagram of luminances where luminances of the first i frames of display images are compensated a plurality of times when a display panel exits a local high-brightness mode according to an embodiment of the present disclosure;

FIG. 13 is a schematic diagram of signal waveforms when a display panel enters and exits a local high-brightness mode according to an embodiment of the present disclosure;

FIG. 14 is a flowchart of another luminance compensation method for a display panel according to an embodiment of the present disclosure;

FIG. 15 is a flowchart of another luminance compensation method for a display panel according to an embodiment of the present disclosure;

FIG. 16 is a flowchart of another luminance compensation method for a display panel according to an embodiment of the present disclosure;

FIG. 17 is a schematic diagram of parameters of a first luminance compensation value according to an embodiment of the present disclosure;

FIG. 18 is a schematic diagram of parameters of a second luminance compensation value according to an embodiment of the present disclosure;

FIG. 19 is a schematic diagram of a structure of a luminance compensation apparatus for a display panel according to an embodiment of the present disclosure; and

FIG. 20 is a schematic diagram of a structure of a display apparatus according to an embodiment of the present disclosure.

### DETAILED DESCRIPTION OF THE EMBODIMENTS

The present disclosure is described in further detail below with reference to the drawings and embodiments. It can be understood that specific embodiments described herein are used merely to explain the present disclosure rather than limit the present disclosure. It should be additionally noted that, for ease of description, only a part of rather than all of the structures related to the present disclosure are shown in the drawings.

With the increasingly wide application of organic light-emitting diode (OLED) display screens, users are imposing stricter requirements on the experience of using the OLED display screens. A display panel includes a pixel drive circuit and a light-emitting device. The pixel drive circuit is connected to the light-emitting device, and is configured to provide a driving current for the light-emitting device and drive the light-emitting device to emit light. The pixel drive circuit includes a drive transistor and a light emission control transistor. A conduction time of the light emission control transistor can be controlled to control the time in which the drive transistor provides the driving current for the light-emitting device, thereby controlling a luminance of the light-emitting device. The conduction time of the light emission control transistor may be controlled by using a pulse width modulation (PWM) signal. During the display of the display panel, dimming may be performed in a pulse width modulation manner. To be specific, a duty cycle of a PWM signal is adjusted to adjust a light-emitting time of the light-emitting device, so as to adjust the luminance of the light-emitting device.

Fingerprint unlocking is one of the most common functions of display panels currently available on the market. Due to the technical requirements of fingerprint recognition, at the same luminance, the duty cycle of the PWM signal after the display panel enters a fingerprint recognition state is different from the duty cycle of the PWM signal in a normal display state to some extent. Consequently, a bias state of the drive transistor in the normal display state is different from a bias state of the drive transistor in the fingerprint recognition state to some extent, thereby leading to a drift of the characteristics of the drive transistor. In this way, when the display panel switches between display states, the luminance of the display image is prone to change, thereby resulting in a visible flicker. The luminance of the display image is a product of the luminance of the light-emitting device and the light-emitting time. As an example, FIG. 1 is a schematic diagram of a display luminance of a display panel in the prior art. In the figure, a horizontal coordinate represents a number of frames NO., and a vertical coordinate represents a luminance Lv (cd/m²). When the display panel enters the fingerprint recognition state f1 from the normal display state, a luminance of at least a previous frame of display image is greater than a luminance of the display image that is in the normal display state, thereby resulting in a visible flicker on the display panel. When the display panel exits the fingerprint recognition state and enters the normal display state f2, a luminance of at least a previous frame of display image is less than a luminance of the display image that is in the normal display state, thereby resulting in a visible flicker on the display panel and reducing the display effect of the display panel.

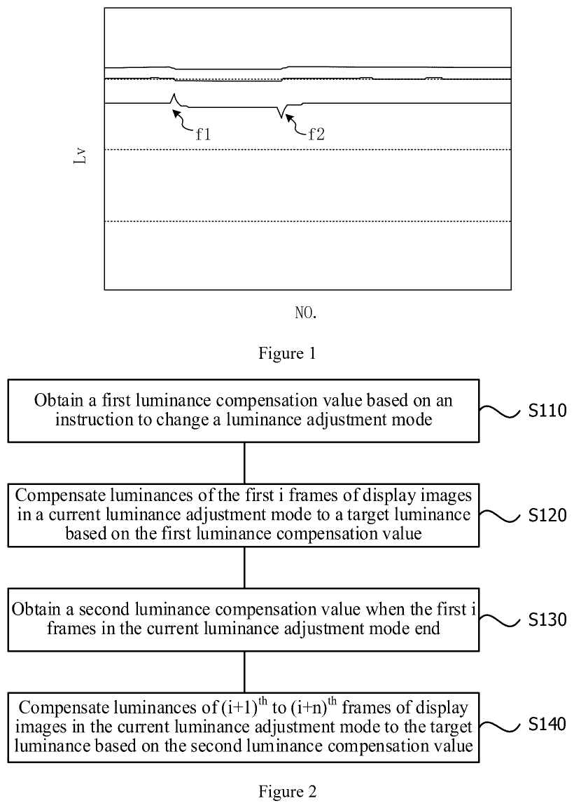

In view of the above technical problems, an embodiment of the present disclosure provides a luminance compensation method for a display panel. FIG. 2 is a flowchart of a luminance compensation method for a display panel according to an embodiment of the present disclosure. A luminance adjustment mode of the display panel includes a pulse width modulation mode. To be specific, a duty cycle of a PWM signal is adjusted to adjust a light-emitting time of a light-emitting device in the display panel, so as to adjust a luminance of the display panel. During the display of the display panel, there are some scenarios in which the duty cycle of the PWM signal in the pulse width modulation mode changes abruptly, thereby causing a visible flicker on the display panel. As an example, display modes of the display panel may include a local high-brightness mode. The duty cycle of the PWM signal is prone to change abruptly when the display panel switches between a normal display mode and the local high-brightness mode. Alternatively, the luminance adjustment mode of the display panel may further include a voltage modulation mode. When the luminance adjustment mode is switched between the voltage modulation mode and the pulse width modulation mode, the duty cycle of the PWM signal is also prone to change abruptly. In this case, the luminance of the display panel can be compensated by the luminance compensation method for the display panel provided in the present disclosure. The method can be performed by a luminance compensation apparatus for a display panel. The luminance compensation apparatus for the display panel may be integrated into a drive chip of the display panel. As shown in FIG. 2, the luminance compensation method for the display panel includes the following steps:

S110: Obtain a first luminance compensation value based on an instruction to change the luminance adjustment mode.

The instruction to change the luminance adjustment mode may include an instruction to change the same luminance adjustment mode, and may also include an instruction to switch between different luminance adjustment modes. As an example, when the luminance adjustment mode of the display panel includes the pulse width modulation mode, the instruction to change the luminance adjustment mode may include an instruction to change the pulse width modulation mode. For example, the instruction to change the pulse width modulation mode may include an instruction to change a duty cycle of a pulse width modulation signal. When the luminance adjustment mode of the display panel further includes the voltage modulation mode, the instruction to change the luminance adjustment mode may further include an instruction to switch between the voltage modulation mode and the pulse width modulation mode. After the instruction to change the luminance adjustment mode is obtained, the duty cycle of the PWM signal changes, and the light-emitting time of the light-emitting device changes. At this time, the data voltage may be adjusted synchronously to adjust the luminance of the light-emitting device. In this way, the luminance of the display panel can be kept unchanged in different frames by adjusting the light-emitting time and luminance of the light-emitting device at the same time. When the data voltage of the display panel changes, the characteristics of the drive transistor in the pixel drive circuit drift. In this way, luminances of the first i frames of display panels after the instruction to change the luminance adjustment mode are different from luminances of (i+1)^{th} to (i+n)^{th} frames of display panels. The first i frames are the time needed for resetting the drifted characteristics of the drive transistor. After the instruction to change the luminance adjustment mode is obtained, the luminances of the first i frames of display panels are different from the luminances of the (i+1)^{th} to (i+n)^{th} frames of display panels. In this case, the first luminance compensation value may be set to correspond to the first i frames of display images, and is used for compensating the luminances of the first i frames of display images to a target luminance. As an example, when the display panel is compensated by an over drive compensation method, the first luminance compensation value may be a compensation value corresponding to the overdrive compensation method.

S120: Compensate luminances of the first i frames of display images in a current luminance adjustment mode to the target luminance based on the first luminance compensation value. Here, i is an integer greater than or equal to 1.

After the instruction to change the luminance adjustment mode is obtained, the luminance adjustment mode is changed from a previous luminance adjustment mode to a current luminance adjustment mode. Specifically, the current luminance adjustment mode and the previous luminance adjustment mode may be the same type of luminance adjustment mode. In this case, a difference between the current luminance adjustment mode and the previous luminance adjustment mode lies in a specific change of the luminance adjustment mode. For example, the luminance adjustment mode is the pulse width modulation mode. The difference between the current luminance adjustment mode and the previous luminance adjustment mode lies in the duty cycle of the PWM signal in the pulse width modulation mode. Alternatively, the current luminance adjustment mode and the previous luminance adjustment mode may be different types of luminance adjustment modes. For example, the previous luminance adjustment mode is the voltage modulation mode, and the current luminance adjustment mode is the pulse width modulation mode. The first luminance compensation value corresponds to the first i frames of display images. The luminances of the first i frames of display images in the current luminance adjustment mode are compensated based on the first luminance compensation value, such that the luminances of the first i frames of display images can be compensated to the target luminance, thereby reducing the difference in the luminance of the display panel caused by the change of the luminance adjustment mode, alleviating the flicker phenomenon of the display panel, and improving the display effect of the display panel.

S130: Obtain a second luminance compensation value when the first i frames in the current luminance adjustment mode end.

The display panel may automatically end the current compensation process after the luminances of the first i frames of display images in the current luminance adjustment mode are compensated based on the first luminance compensation value. After the first i frames end, the characteristics of the drive transistor are reset, and the difference in the luminance of the display panel falls outside a visible range. At this time, the second luminance compensation value is obtained. The second luminance compensation value corresponds to the remaining frames of display images in the current luminance adjustment mode, and is used for compensating luminances of the remaining frames of display images in the current luminance adjustment mode to the target luminance. As an example, when i is 1 and a number of frames in the current luminance adjustment mode is n, the remaining frames in the current luminance adjustment mode are second to n^{th} frames in the current luminance adjustment mode. Here, n is an integer greater than 1. The second luminance compensation value may be a luminance compensation value conventionally set in the display panel, that is, a luminance compensation value of the display panel in the normal display mode. As an example, the second luminance compensation value may be a compensation value used for removing brightness non-uniformity (Demura), and is used for compensating for the brightness non-uniformity phenomenon of the display panel (that is, the mura phenomenon of the display panel) in the normal display mode.

S140: Compensate the luminances of the (i+1)^{th} to (i+n)^{th} frames of display images in the current luminance adjustment mode to the target luminance based on the second luminance compensation value. Here, n is an integer greater than 1, and the (i+n)^{th} frame of display image is the last frame of display image in the current luminance adjustment mode.

After the second luminance compensation value is obtained, the luminances of the (i+1)^{th} to (i+n)^{th} frames of display images in the current luminance adjustment mode are compensated to the target luminance based on the second luminance compensation value, thereby implementing luminance compensation for the display panel in the normal display mode, and improving the brightness uniformity of the display images. When the luminances of the (i+1)^{th} to (i+n)^{th} frames of display images in the current luminance adjustment mode are compensated by using the second luminance compensation value, the luminance compensation value of the display panel in the normal display mode can be fully used, thereby reducing the additionally set luminance compensation value, lowering the performance requirement on the drive chip of the display panel, and reducing the costs of the display panel. As an example, the requirement on the space of the memory used for storing the luminance compensation values in the drive chip of the display panel can be reduced.

In one embodiment, the first luminance compensation value is set additionally, and the first luminance compensation value is obtained based on the instruction to change the luminance adjustment mode. The luminances of the first i frames of display panels in the current luminance adjustment mode are compensated, thereby alleviating the flicker phenomenon of the display panel and improving the display effect of the display panel. In addition, the luminances of the (i+1)^{th} to (i+n)^{th} frames of display panels in the current luminance adjustment mode are compensated by using the second luminance compensation value of the display panel in the normal display mode, thereby ensuring brightness uniformity of the display panel, reducing the additionally set luminance compensation value, lowering the performance requirement on the drive chip of the display panel, and reducing the costs of the display panel.

On the basis of the above embodiments, a display mode of the display panel includes a local high-brightness mode. The luminance compensation method for the display panel further includes:
obtaining, when the display mode of the display panel enters or exits the local high-brightness mode, the instruction to change the luminance adjustment mode.

Specifically, the local high-brightness mode is applicable to a fingerprint recognition function of the display panel. After the display panel enters the fingerprint recognition state, the display mode of the display panel may be the local high-brightness mode to ensure the reliability of fingerprint recognition. When the display mode of the display panel enters the local high-brightness mode from the normal display mode, the duty cycle of the PWM signal changes to a very large value at different gray levels and different display luminance levels. In one embodiment, at a low gray level and a low display luminance level, when the display mode of the display panel changes from the normal display mode to the local high-brightness mode, the duty cycle of the PWM signal changes abruptly to a great extent. The abrupt change of the duty cycle is prone to cause an abrupt change in the data voltage, and thus cause an abrupt change in the luminance of the display panel, which is presented as a visible flicker phenomenon. When the display mode of the display panel exits the local high-brightness mode and enters the normal display mode, the duty cycle of the PWM signal changes to a very small value at a low gray level and a low display luminance level. This case also causes an abrupt change in the data voltage, and thus causes an abrupt change in the luminance of the display panel, which is presented as a visible flicker phenomenon. In this case, it can be set that when the display mode of the display panel enters or exits the local high-brightness mode, the instruction to change the luminance adjustment mode is obtained, to start additional luminance compensation for the first i frames of display images after the luminance adjustment mode changes. As an example, when the local high-brightness mode is applied to the fingerprint recognition function of the display panel, and when the display mode of the display panel enters the local high-brightness mode from the normal display mode, the instruction to change the luminance adjustment mode may be an instruction to enable the fingerprint recognition function. When the display mode of the display panel exits the local high-brightness mode and enters the normal display mode, the instruction to change the luminance adjustment mode may be an instruction to disable the fingerprint recognition function.

In some embodiments, the first luminance compensation value includes a first entry luminance compensation value when the display mode of the display panel enters the local high-brightness mode. FIG. 3 is a flowchart of another luminance compensation method for a display panel according to an embodiment of the present disclosure. As shown in FIG. 3, the luminance compensation method for the display panel includes the following steps:

S210: Obtain the first luminance compensation value based on an instruction to change a luminance adjustment mode.

S220: Decrease luminances of the first i frames of display images in a current luminance adjustment mode to a target luminance based on the first entry luminance compensation value.

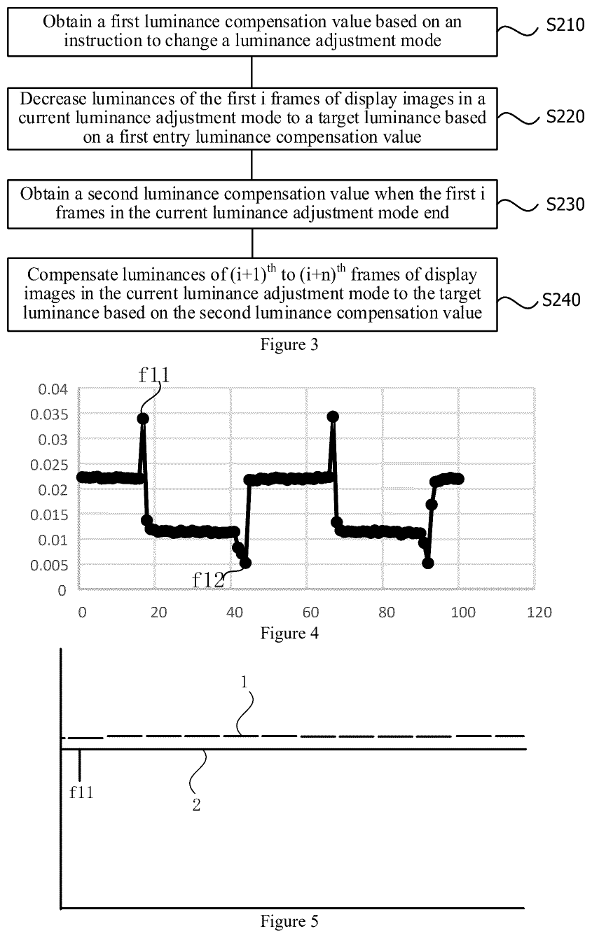

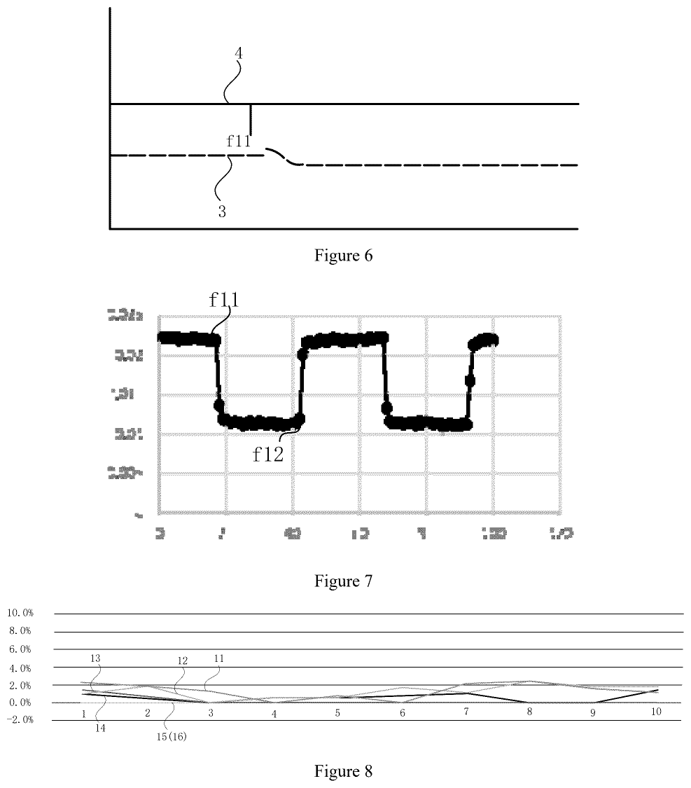

When the display mode of the display panel enters the local high-brightness mode, the duty cycle of the PWM signal is increased. To keep the luminance of the display panel unchanged, the data voltage is adjusted to reduce a driving current supplied by the drive transistor. When the data voltage changes, the characteristics of the drive transistor drift, so that the driving current supplied by the drive transistor is gradually reduced through the first i frames. In this way, the luminances of the first i frames of display images in the current luminance adjustment mode are greater than the target luminance. As an example, FIG. 4 is a schematic diagram of luminances when a luminance adjustment mode of a display panel changes according to an embodiment of the present disclosure. In the figure, a horizontal coordinate represents a number of frames, and a vertical coordinate represents a luminance. As shown in FIG. 4, when a display luminance level of the display panel is 2 nits and a gray level of the display panel is 32, and when the display mode of the display panel enters the local high-brightness mode f11, the luminance of the display panel rises from 0.021 nits to 0.033 nits, with a luminance fluctuation of 54%. FIG. 5 is a schematic diagram of simulation of data voltages when a display panel enters a local high-brightness mode in the prior art. FIG. 6 is a schematic diagram of simulation of data voltages when a display panel enters a local high-brightness mode according to an embodiment of the present disclosure. In the figures, curve 1 and curve 3 are data voltage curves, and curve 2 and curve 4 are schematic curves at the moment of entering the local high-brightness mode. As shown in FIG. 5 and FIG. 6, in the prior art, after entry into the local high-brightness mode f11, the data voltage remains unchanged. In the present disclosure, when the drive transistor is a p-type transistor, the data voltage may be increased by using the first entry luminance compensation value. In this way, the driving current can be decreased, and thus the luminances of the first i frames of display images in the current luminance adjustment mode can be decreased to the target luminance, thereby reducing the difference in the luminance of the display panel caused by the change of the luminance adjustment mode, alleviating the flicker phenomenon of the display panel, and improving the display effect of the display panel. As an example, FIG. 7 is a schematic diagram of luminances when luminances of the first i frames of display images are compensated by using a first luminance compensation value when a display panel enters a local high-brightness mode according to an embodiment of the present disclosure. In the figure, a horizontal coordinate represents a number of frames, and a vertical coordinate represents a luminance. As shown in FIG. 7, when the display luminance level of the display panel is 2 nits and the gray level is 32, a maximum luminance fluctuation is approximately 5% after the luminances of the first i frames of display images in the current luminance adjustment mode are compensated by using the first entry luminance compensation value. In this way, the luminances of the first i frames of display images in the current luminance adjustment mode can be compensated by using the first entry luminance compensation value, thereby reducing the difference in the luminance of the display panel caused by the change of the luminance adjustment mode, alleviating the flicker phenomenon of the display panel, and improving the display effect of the display panel.

It should be noted that, in other embodiments, luminance compensation may alternatively be performed for other gray levels and other display luminance levels. As an example, FIG. 8 is a schematic diagram of luminances of the first i frames of display images are compensated a plurality of times in an experiment when a display panel enters a local high-brightness mode according to an embodiment of the present disclosure. In the figure, a horizontal coordinate represents a number of times the luminances of the first i frames of display images in the current luminance adjustment mode are decreased to the target luminance based on the first entry luminance compensation value; and a vertical coordinate represents a luminance fluctuation rate after luminance compensation, that is, a ratio of a difference to the target luminance, where the difference is a difference between the luminance after luminance compensation and the target luminance. Curve 11 is a curve showing a luminance fluctuation rate after luminance compensation is performed by using the first luminance compensation value when the display luminance level is 2 nits and the gray level is 255. Curve 12 is a curve showing a luminance fluctuation rate after luminance compensation is performed by using the first luminance compensation value when the display luminance level is 5 nits and the gray level is 255. Curve 13 is a curve showing a luminance fluctuation rate after luminance compensation is performed by using the first luminance compensation value when the display luminance level is 10 nits and the gray level is 255. Curve 14 is a curve showing a luminance fluctuation rate after luminance compensation is performed by using the first luminance compensation value when the display luminance level is 30 nits and the gray level is 255. Curve 15 is a curve showing a luminance fluctuation rate after luminance compensation is performed by using the first luminance compensation value when the display luminance level is 89.8 nits and the gray level is 32. Curve 16 is a curve showing a luminance fluctuation rate after luminance compensation is performed by using the first luminance compensation value when the display luminance level is 89.8 nits and the gray level is 255. Among the curves, different curves overlap to some extent, and curve 15 and curve 16 mostly overlap. As shown in FIG. 8, at different gray levels and different display luminance levels, a maximum luminance fluctuation rate after luminance compensation is approximately 2%. Therefore, as can be seen, the luminances of the first i frames of display images in the current luminance adjustment mode are compensated by using the first entry luminance compensation value, thereby effectively reducing the difference in the luminance of the display panel caused by the change of the luminance adjustment mode, alleviating the flicker phenomenon of the display panel, and improving the display effect of the display panel.

S230: Obtain a second luminance compensation value when the first i frames in the current luminance adjustment mode end.

S240: Compensate luminances of (i+1)^{th} to (i+n)^{th} frames of display images in the current luminance adjustment mode to the target luminance based on the second luminance compensation value.

In one embodiment, when the display mode of the display panel enters the local high-brightness mode, the current luminance adjustment mode is the local high-brightness mode.

In one embodiment, i is less than or equal to 5.

Specifically, when the characteristics of the drive transistor drift, the drifted characteristics of the drive transistor can be reset within 5 frames. In this case, i is set to be less than or equal to 5, thereby not only alleviating the flicker phenomenon of the display panel, but also reducing the additionally set first luminance compensation value, lowering the performance requirement on the drive chip of the display panel, and reducing the costs of the display panel.

In one embodiment, i is less than or equal to 3.

Specifically, when the characteristics of the drive transistor drift, the characteristics of most types of drive transistors can be reset within 3 frames. In this case, i is set to be less than or equal to 3, thereby alleviating most of the flicker phenomenon of the display panel, and further reducing the additionally set first luminance compensation value.

In other embodiments, further In one embodiment, i is equal to 1, thereby alleviating the flicker phenomenon of the display panel to some extent, and further reducing the additionally set first luminance compensation value.

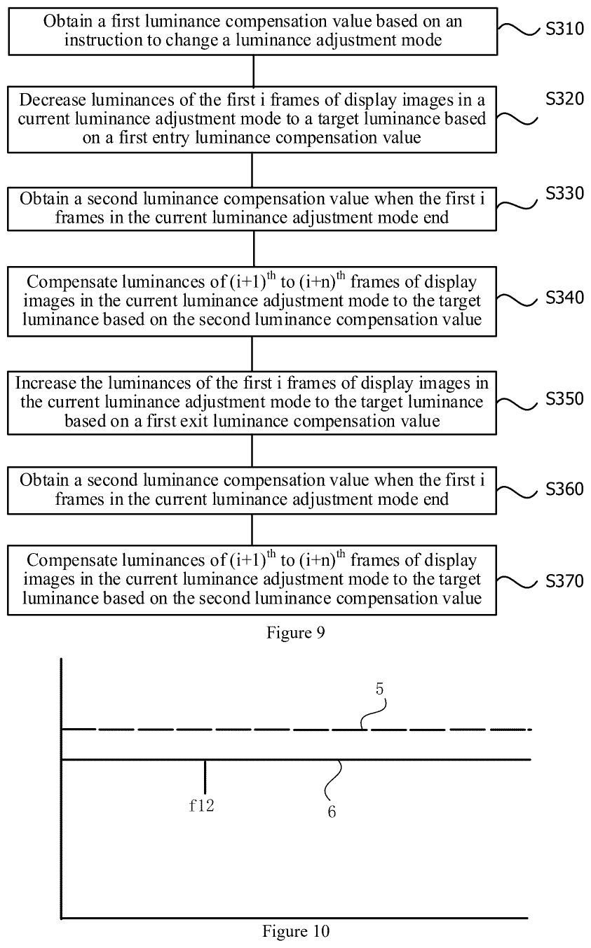

In some embodiments, the first luminance compensation value includes a first exit luminance compensation value when the display mode of the display panel exits the local high-brightness mode. FIG. 9 is a flowchart of another luminance compensation method for a display panel according to an embodiment of the present disclosure. As shown in FIG. 9, the luminance compensation method for the display panel includes the following steps:

S310: Obtain the first luminance compensation value based on an instruction to change a luminance adjustment mode.

S320: Decrease luminances of the first i frames of display images in a current luminance adjustment mode to a target luminance based on a first entry luminance compensation value.

In this step, when the display mode of the display panel enters the local high-brightness mode, the current luminance adjustment mode of the display panel is the local high-brightness mode. In this case, the luminances of the first i frames of display images in the local high-brightness mode are decreased to the target luminance based on the first entry luminance compensation value.

S330: Obtain a second luminance compensation value when the first i frames in the current luminance adjustment mode end.

S340: Compensate luminances of (i+1)^{th} to (i+n)^{th} frames of display images in the current luminance adjustment mode to the target luminance based on the second luminance compensation value.

In this case, the luminances of the (i+1)^{th} to (i+n)^{th} frames of display images in the local high-brightness mode may be compensated to the target luminance based on the second luminance compensation value.

S350: Increase the luminances of the first i frames of display images in the current luminance adjustment mode to the target luminance based on the first exit luminance compensation value.

In this step, when the display mode of the display panel exits the local high-brightness mode, the current luminance adjustment mode of the display panel is a normal display mode. In this case, the luminances of the first i frames of display images in the normal display mode are increased to the target luminance based on the first exit luminance compensation value.

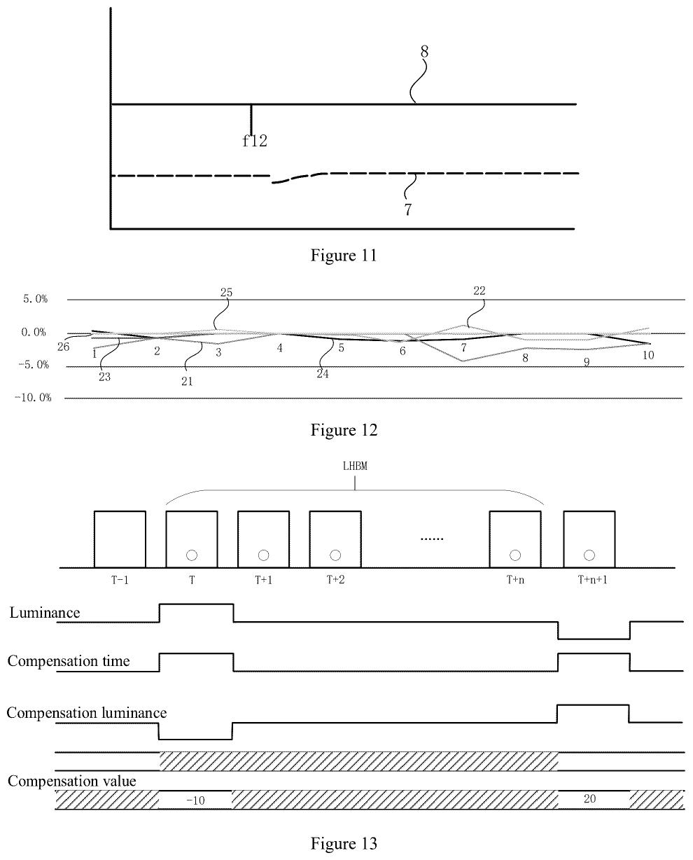

When the local high-brightness mode is applied to a fingerprint recognition function of the display panel, after fingerprint recognition is completed, the display mode of the display panel exits the local high-brightness mode and enters the normal display mode. At this time, the duty cycle of the PWM signal is reduced. To keep the luminance of the display panel unchanged, the data voltage is adjusted to increase the driving current supplied by the drive transistor. When the data voltage changes, the characteristics of the drive transistor drift, so that the driving current supplied by the drive transistor is gradually increased through the first i frames. In this way, the luminances of the first i frames of display images in the current luminance adjustment mode are less than the target luminance. As an example, still referring to FIG. 4, when a display luminance level of the display panel is 2 nits and a gray level of the display panel is 32, and when the display mode of the display panel exits the local high-brightness mode f12, the luminance of the display panel drops from 0.01 nits to 0.005 nits, with a luminance fluctuation of 50%. FIG. 10 is a schematic diagram of simulation of data voltages when a display panel exits a local high-brightness mode in the prior art. FIG. 11 is a schematic diagram of simulation of data voltages when a display panel exits a local high-brightness mode according to an embodiment of the present disclosure. In the figures, curve 5 and curve 7 are data voltage curves, and curve 6 and curve 8 are schematic curves at the moment of exiting the local high-brightness mode. As shown in FIG. 10 and FIG. 11, in the prior art, after exit from the local high-brightness mode f12, the data voltage remains unchanged. In the present disclosure, when the drive transistor is a p-type transistor, the data voltage may be decreased by using the first exit luminance compensation value. In this way, the driving current can be increased, and thus the luminances of the first i frames of display images in the current luminance adjustment mode can be increased to the target luminance, thereby reducing the difference in the luminance of the display panel caused by the change of the luminance adjustment mode, alleviating the flicker phenomenon of the display panel, and improving the display effect of the display panel. As an example, still referring to FIG. 7, when the display luminance level of the display panel is 2 nits and the gray level is 32, a maximum luminance fluctuation is approximately 5% after the luminances of the first i frames of display images in the current luminance adjustment mode are compensated by using the first exit luminance compensation value. In this way, the luminances of the first i frames of display images in the current luminance adjustment mode can be compensated by using the first exit luminance compensation value, thereby reducing the difference in the luminance of the display panel caused by the change of the luminance adjustment mode, alleviating the flicker phenomenon of the display panel, and improving the display effect of the display panel.

It should be noted that, in other embodiments, luminance compensation may alternatively be performed for other gray levels and other display luminance levels. As an example, FIG. 12 is a schematic diagram of luminances when luminances of the first i frames of display images are compensated a plurality of times when a display panel exits a local high-brightness mode according to an embodiment of the present disclosure. In the figure, a horizontal coordinate represents a number of times the luminances of the first i frames of display images in the current luminance adjustment mode are increased to the target luminance based on the first exit luminance compensation value; and a vertical coordinate represents a luminance fluctuation rate after luminance compensation. Curve 21 is a curve showing a luminance fluctuation rate after luminance compensation is performed by using the first luminance compensation value when the display luminance level is 2 nits and the gray level is 255. Curve 22 is a curve showing a luminance fluctuation rate after luminance compensation is performed by using the first luminance compensation value when the display luminance level is 5 nits and the gray level is 255. Curve 23 is a curve showing a luminance fluctuation rate after luminance compensation is performed by using the first luminance compensation value when the display luminance level is 10 nits and the gray level is 255. Curve 24 is a curve showing a luminance fluctuation rate after luminance compensation is performed by using the first luminance compensation value when the display luminance level is 30 nits and the gray level is 255. Curve 25 is a curve showing a luminance fluctuation rate after luminance compensation is performed by using the first luminance compensation value when the display luminance level is 89.8 nits and the gray level is 32. Curve 26 is a curve showing a luminance fluctuation rate after luminance compensation is performed by using the first luminance compensation value when the display luminance level is 89.8 nits and the gray level is 255. As shown in FIG. 12, at different gray levels and different display luminance levels, a luminance fluctuation rate after luminance compensation is at most 5%.

Therefore, as can be seen, the luminances of the first i frames of display images in the current luminance adjustment mode are compensated by using the first exit luminance compensation value, thereby effectively reducing the difference in the luminance of the display panel caused by the change of the luminance adjustment mode, alleviating the flicker phenomenon of the display panel, and improving the display effect of the display panel.

Still referring to FIG. 9, in other embodiments, the luminance compensation method for the display panel further includes:

S360: Obtain a second luminance compensation value when the first i frames in the current luminance adjustment mode end.

S370: Compensate luminances of (i+1)^{th} to (i+n)^{th} frames of display images in the current luminance adjustment mode to the target luminance based on the second luminance compensation value.

After luminance compensation is performed for the first i frames after exit from the local high-brightness mode, a second luminance compensation value may be further obtained. In this case, the luminances of the (i+1)^{th} to (i+n)^{th} frames of display images in a normal display mode are compensated to the target luminance based on the second luminance compensation value, thereby improving the brightness uniformity of the display panel.

On the basis of the above embodiments, in one embodiment, i is less than or equal to 5.

Specifically, when the characteristics of the drive transistor drift, the drifted characteristics of the drive transistor can be reset within 5 frames. In this case, i is set to be less than or equal to 5, thereby not only alleviating the flicker phenomenon of the display panel, but also reducing the additionally set first luminance compensation value, lowering the performance requirement on the drive chip of the display panel, and reducing the costs of the display panel.

In one embodiment, i is less than or equal to 3.

Specifically, when the characteristics of the drive transistor drift, the characteristics of most types of drive transistors can be reset within 3 frames. In this case, i is set to be less than or equal to 3, thereby alleviating most of the flicker phenomenon of the display panel, and further reducing the additionally set first luminance compensation value.

In other embodiments, further in one embodiment, i is equal to 1, thereby alleviating the flicker phenomenon of the display panel to some extent, and further reducing the additionally set first luminance compensation value.

It should be noted that, during display of the display panel, when the display mode of the display panel includes a switching process during which the display mode enters the local high-brightness mode and exits the local high-brightness mode concurrently, the value of i when the display mode enters the local high-brightness mode may be the same as or different from the value of i when the display mode exits the local high-brightness mode on the display panel, which is not limited here.

As an example, FIG. 13 is a schematic diagram of signal waveforms when a display panel enters and exits a local high-brightness mode according to an embodiment of the present disclosure. As shown in FIG. 13, when the display panel enters the local high-brightness mode and i is equal to 1, the display panel may be triggered by an instruction such as an 8301 instruction of a drive chip, so that a luminance of one frame on the display panel is compensated by using the first luminance compensation value, and the display panel automatically ends the current compensation process after completion of compensating the luminance of the frame. At the first frame T after the display panel enters the local high-brightness mode (LHBM), the luminance of the first frame T on the display panel in the local high-brightness mode is greater than luminances of other frames. In this case, a compensation time for the first entry luminance compensation value is the first frame T in the local high-brightness mode, and the luminance compensation value of the first frame T in the local high-brightness mode is −10. In other words, the compensation luminance of the first frame T in the local high-brightness mode is less than compensation luminances of other frames. In this way, the luminance of the first frame T in the local high-brightness mode is decreased to the target luminance. When the display panel exits the local high-brightness mode and i is equal to 1, the display panel may be triggered by an instruction such as an 8300 instruction of a drive chip, so that the luminance of one frame on the display panel is compensated by using the first luminance compensation value, and the display panel automatically ends the current compensation process after completion of compensating the luminance of the frame. At the first frame (frame T+n+1) after the display panel exits the local high-brightness mode, a luminance of the first frame (frame T+n+1) on the display panel out of the local high-brightness mode is less than luminances of other frames. In this case, a compensation time for the first exit luminance compensation value is the first frame (frame T+n+1) out of the local high-brightness mode, and the luminance compensation value of the first frame (frame T+n+1) out of the local high-brightness mode is 20. In other words, the compensation luminance of the first frame (frame T+n+1) out of the local high-brightness mode is greater than compensation luminances of other frames. In this way, the luminance of the first frame (frame T+n+1) out of the local high-brightness mode is increased to the target luminance.

On the basis of the above embodiments, a number of frames of display images with luminances compensated based on the first luminance compensation value when the display mode of the display panel enters the local high-brightness mode is the same as a number of frames of display images with luminances compensated based on the first luminance compensation value when the display mode of the display panel exits the local high-brightness mode.

Specifically, a number of frames needed for resetting the drive transistor when the display mode of the display panel enters the local high-brightness mode is substantially the same as a number of frames needed for resetting the drive transistor when the display mode exits the local high-brightness mode. In this case, the number of frames of display images with luminances compensated based on the first luminance compensation value when the display mode of the display panel enters the local high-brightness mode may be set to be the same as the number of frames of display images with luminances compensated based on the first luminance compensation value when the display mode of the display panel exits the local high-brightness mode, thereby simplifying the display driving process of the display panel.

On the basis of the above embodiments, the luminance adjustment mode further includes a voltage modulation mode. The luminance compensation method for the display panel further includes:
obtaining, when the voltage modulation mode and the pulse width modulation mode are switched to each other, the instruction to change the luminance adjustment mode.

Specifically, the voltage modulation mode is a dimming method that adjusts a luminance of a light-emitting device in the display panel by adjusting the data voltage. The display panel may include both the voltage modulation mode and the pulse width modulation mode. When the display luminance level is located in a region at either an upper end or a lower end of a luminance range, the voltage modulation mode may be used for dimming. When the display luminance level is located in a middle region of the luminance range, the dimming may be performed by using the pulse width modulation mode. When the luminance adjustment mode is switched from the voltage modulation mode to the pulse width modulation mode, the duty cycle of the PWM signal changes to a very small value. This is likely to cause an abrupt change in the data voltage, and thus cause an abrupt change in the luminance of the display panel, which is presented as a visible flicker phenomenon. When the luminance adjustment mode is switched from the pulse width modulation mode to the voltage modulation mode, the duty cycle of the PWM signal changes to a very large value. This is also likely to cause an abrupt change in the data voltage, and thus cause an abrupt change in the luminance of the display panel, which is presented as a visible flicker phenomenon.

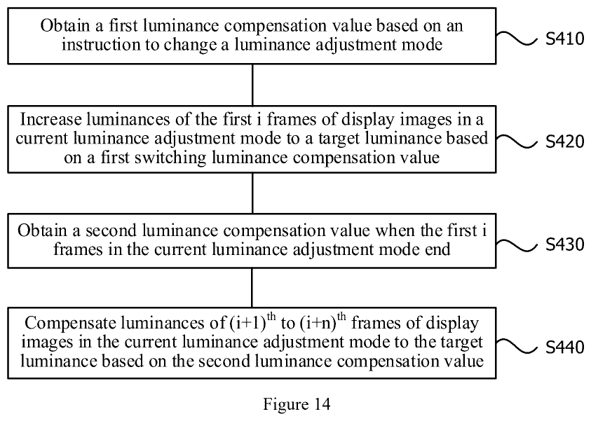

In some embodiments, when the luminance adjustment mode is switched from the voltage modulation mode to the pulse width modulation mode, the first luminance compensation value includes a first switching luminance compensation value. FIG. 14 is a flowchart of another luminance compensation method for a display panel according to an embodiment of the present disclosure. As shown in FIG. 14, the luminance compensation method for the display panel includes the following steps:

S410: Obtain a first luminance compensation value based on an instruction to change a luminance adjustment mode.

S420: Increase luminances of the first i frames of display images in a current luminance adjustment mode to a target luminance based on the first switching luminance compensation value.

In this step, when the luminance adjustment mode is switched from the voltage modulation mode to the pulse width modulation mode, the duty cycle of the PWM signal is changed to a very small value. To keep the luminance of the display panel unchanged, the data voltage is adjusted to increase the driving current supplied by the drive transistor. When the data voltage changes, the characteristics of the drive transistor drift, so that the driving current supplied by the drive transistor is gradually increased through the first i frames. In this way, the luminances of the first i frames of display images in the current luminance adjustment mode are less than the target luminance. In this case, the luminances of the first i frames of display images in the current luminance adjustment mode can be increased to the target luminance by using the first switching luminance compensation value, thereby reducing the difference in the luminance of the display panel caused by the change of the luminance adjustment mode, alleviating the flicker phenomenon of the display panel, and improving the display effect of the display panel.

S430: Obtain a second luminance compensation value when the first i frames in the current luminance adjustment mode end.

S440: Compensate luminances of (i+1)^{th} to (i+n)^{th} frames of display images in the current luminance adjustment mode to the target luminance based on the second luminance compensation value.

On the basis of the technical solution of the above embodiment, the current luminance adjustment mode is the pulse width modulation mode.

In one embodiment, i is less than or equal to 5.

In one embodiment, i is less than or equal to 3.

In one embodiment, i is equal to 1.

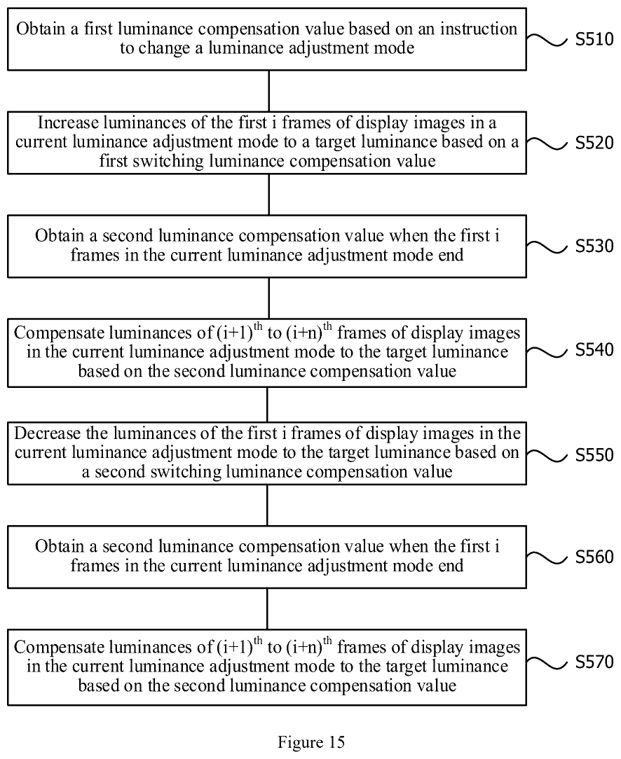

In some embodiments, when the luminance adjustment mode is switched from the pulse width modulation mode to the voltage modulation mode, the first luminance compensation value includes a second switching luminance compensation value. FIG. 15 is a flowchart of another luminance compensation method for a display panel according to an embodiment of the present disclosure. As shown in FIG. 15, the luminance compensation method for the display panel includes the following steps:

S510: Obtain the first luminance compensation value based on an instruction to change a luminance adjustment mode.

S520: Increase luminances of the first i frames of display images in a current luminance adjustment mode to a target luminance based on a first switching luminance compensation value.

In this step, when the luminance adjustment mode is switched from the voltage modulation mode to the pulse width modulation mode, the current luminance adjustment mode of the display panel is the pulse width modulation mode. In this case, the luminances of the first i frames of display images in the pulse width modulation mode are increased to the target luminance based on the first switching luminance compensation value.

S530: Obtain a second luminance compensation value when the first i frames in the current luminance adjustment mode end.

S540: Compensate luminances of (i+1)^{th} to (i+n)^{th} frames of display images in the current luminance adjustment mode to the target luminance based on the second luminance compensation value.

In this case, the luminances of the (i+1)^{th} to (i+n)^{th} frames of display images in the pulse width modulation mode may be compensated to the target luminance based on the second luminance compensation value.

S550: Decrease the luminances of the first i frames of display images in the current luminance adjustment mode to the target luminance based on the second switching luminance compensation value.

In this step, when the luminance adjustment mode is switched from the pulse width modulation mode to the voltage modulation mode, the current luminance adjustment mode of the display panel is the voltage modulation mode. In this case, the luminances of the first i frames of display images in the voltage modulation mode are decreased to the target luminance based on the second switching luminance compensation value.

When the luminance adjustment mode is switched from the pulse width modulation mode to the voltage modulation mode, the duty cycle of the PWM signal is increased. To keep the luminance of the display panel unchanged, the data voltage is adjusted to decrease the driving current supplied by the drive transistor. When the data voltage changes, the characteristics of the drive transistor drift, so that the driving current supplied by the drive transistor is gradually reduced through the first i frames. In this way, the luminances of the first i frames of display images in the current luminance adjustment mode are greater than the target luminance. In this case, the luminances of the first i frames of display images in the current luminance adjustment mode can be decreased to the target luminance by using the second switching luminance compensation value, thereby reducing the difference in the luminance of the display panel caused by the change of the luminance adjustment mode, alleviating the flicker phenomenon of the display panel, and improving the display effect of the display panel.

Still referring to FIG. 15, in other embodiments, the luminance compensation method for the display panel further includes:

S560: Obtain a second luminance compensation value when the first i frames in the current luminance adjustment mode end.

S570: Compensate the luminances of the (i+1)^{th} to (i+n)^{th} frames of display images in the current luminance adjustment mode to the target luminance based on the second luminance compensation value.

In this step,
after luminance compensation is performed for the first i frames when the luminance adjustment mode is switched from the pulse width modulation mode to the voltage modulation mode, a second luminance compensation value may be further obtained. In this case, the luminances of the (i+1)^{th} to (i+n)^{th} frames of display images in the voltage modulation mode may be compensated to the target luminance based on the second luminance compensation value, thereby improving the brightness uniformity of the display panel.

On the basis of the above embodiments, in one embodiment, i is less than or equal to 5.

In one embodiment, i is less than or equal to 3.

In one embodiment, i is equal to 1.

It should be noted that, during display of the display panel, when the luminance adjustment mode of the display panel includes both the voltage modulation mode and the pulse width modulation mode switched to each other, the value of i when the luminance adjustment mode of the display panel is switched from the voltage modulation mode to the pulse width modulation mode may be the same as or different from the value of i when the luminance adjustment mode is switched from the pulse width modulation mode to the voltage modulation mode, which is not limited here.

On the basis of the above embodiments, a number of frames of display images with luminances compensated based on the first luminance compensation value when the luminance adjustment mode is switched from the voltage modulation mode to the pulse width modulation mode is the same as a number of frames of display images with luminances compensated based on the first luminance compensation value when the luminance adjustment mode is switched from the pulse width modulation mode to the voltage modulation mode.

A number of frames needed for resetting the drive transistor when the luminance adjustment mode is switched from the voltage modulation mode to the pulse width modulation mode is substantially the same as a number of frames needed for resetting the drive transistor when the luminance adjustment mode is switched from the pulse width modulation mode to the voltage modulation mode. In this case, the number of frames of display images with luminances compensated based on the first luminance compensation value when the luminance adjustment mode is switched from the voltage modulation mode to the pulse width modulation mode may be set to be the same as the number of frames of display images with luminances compensated based on the first luminance compensation value when the luminance adjustment mode is switched from the pulse width modulation mode to the voltage modulation mode, thereby simplifying the display driving process of the display panel.

On the basis of the above embodiments, the compensating luminances of the first i frames of display images in a current luminance adjustment mode to a target luminance based on the first luminance compensation value includes:
compensating the luminances of the first i frames of display images in the current luminance adjustment mode to a first luminance based on the first luminance compensation value.

The first luminance is an actual luminance of the first i frames of display images after the luminances of the first i frames of display images are compensated by using the first luminance compensation value.

When a difference between the first luminance and the target luminance is less than a first threshold, it is determined that the first luminance is the target luminance.

The target luminance is a target luminance of the first i frames of display images after the luminances of the first i frames of display images are compensated by using the first luminance compensation value. The first threshold may be set based on user needs. In some embodiments, the first threshold may be determined based on a luminance difference corresponding to the visible flicker phenomenon. In other words, the first threshold may be less than or equal to the luminance difference corresponding to the visible flicker phenomenon. After the luminances of the first i frames of display images in the current luminance adjustment mode are compensated to the first luminance by using the first entry luminance compensation value, when the difference between the first luminance and the target luminance is less than the first threshold, it may be determined that the difference between the first luminance and the target luminance falls within a user-acceptable range, and meets the user requirement on the luminance of the display panel. In this case, it may be determined that the first luminance is the target luminance, and the luminance compensation for the display panel is completed.

On the basis of the above embodiments, after the compensating the luminances of the first i frames of display images in the current luminance adjustment mode to a first luminance based on the first luminance compensation value, the method further includes: adjusting the first luminance compensation value when the difference between the first luminance and the target luminance is greater than or equal to the first threshold.

When the difference between the first luminance and the target luminance is greater than or equal to the first threshold, the difference between the first luminance and the target luminance falls outside the user-acceptable range and fails to meet the user requirement on the luminance of the display panel. In this case, the first luminance compensation value may be adjusted, so that the difference between the first luminance and the target luminance of the display image is less than the first threshold after the compensation is performed based on the first luminance compensation value, thereby meeting the user requirement on the luminance of the display panel.

On the basis of the above embodiments, the adjusting the first luminance compensation value when the difference between the first luminance and the target luminance is greater than or equal to the first threshold includes:
adjusting the first luminance compensation value when the first luminance is greater than the target luminance, so as to decrease the first luminance.

When the first luminance is greater than the target luminance, the first luminance compensation value may be adjusted to decrease the first luminance and reduce the difference between the first luminance and the target luminance. As an example, when the display mode of the display panel enters the local high-brightness mode, the first entry luminance compensation value may be increased to increase the luminance level of the display image decreased by using the first entry luminance compensation value. When the display mode of the display panel exits the local high-brightness mode, the first exit luminance compensation value may be reduced to decrease the luminance level of the display image increased by using the first exit luminance compensation value. When the luminance adjustment mode is switched from the voltage modulation mode to the pulse width modulation mode, the first switching luminance compensation value may be reduced to reduce the luminance level of the display image increased by using the first switching luminance compensation value. When the luminance adjustment mode is switched from the pulse width modulation mode to the voltage modulation mode, the second switching luminance compensation value may be increased to increase the luminance level of the display image decreased by the second switching luminance compensation value.

When the first luminance is less than the target luminance, the first luminance compensation value is adjusted to increase the first luminance.

When the first luminance is less than the target luminance, the first luminance compensation value may be adjusted to increase the first luminance and reduce the difference between the first luminance and the target luminance. As an example, when the display mode of the display panel enters the local high-brightness mode, the first entry luminance compensation value may be reduced to decrease the luminance level of the display image decreased by using the first entry luminance compensation value. When the display mode of the display panel exits the local high-brightness mode, the first exit luminance compensation value may be increased to increase the luminance level of the display image increased by using the first exit luminance compensation value. When the luminance adjustment mode is switched from the voltage modulation mode to the pulse width modulation mode, the first switching luminance compensation value may be increased to increase the luminance level of the display image increased by using the first switching luminance compensation value. When the luminance adjustment mode is switched from the pulse width modulation mode to the voltage modulation mode, the second switching luminance compensation value may be reduced to decrease the luminance level of the display image decreased by using the second switching luminance compensation value.

On the basis of the above embodiments, compensating the luminances of the display images to the target luminance based on the first luminance compensation value or the second luminance compensation value includes:
determining a gamma value based on a luminance compensation value. The luminance compensation value includes the first luminance compensation value or the second luminance compensation value.

The luminance compensation value may be a digital value. After the luminance compensation value is determined, the luminance compensation value may be output to a gamma value determining unit to determine a gamma value. The gamma value may be a digital value.

A data voltage is determined based on the gamma value.

After the gamma value is determined, the data voltage may be determined based on the gamma value to implement digital-to-analog conversion of a driving signal.

The display panel is driven to display the display images based on the data voltage.

After the data voltage is determined, the data voltage is output to a pixel drive circuit of the display panel. In this way, the pixel drive circuit generates a corresponding driving current based on the data voltage, and drives a light-emitting device to emit light, so that the display panel displays the display images.

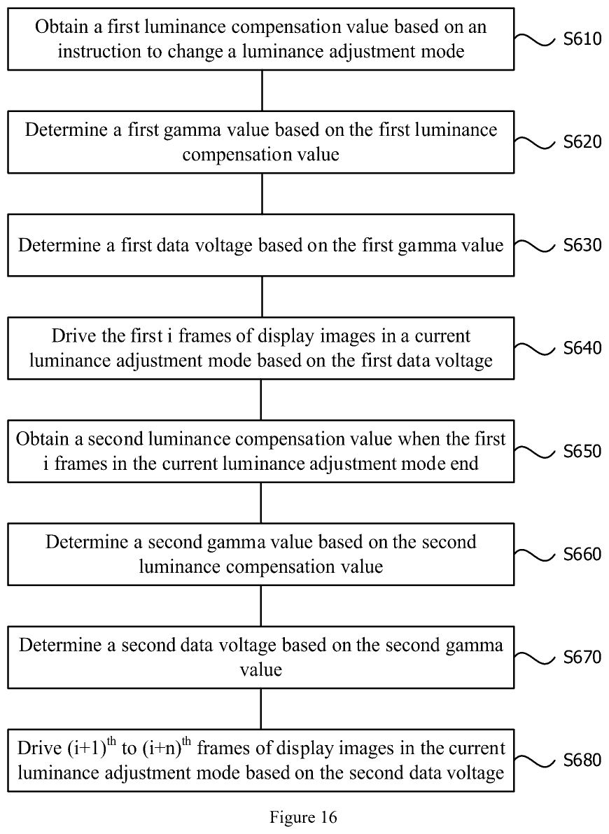

As an example, FIG. 16 is a flowchart of another luminance compensation method for a display panel according to an embodiment of the present disclosure. As shown in FIG. 16, the luminance compensation method for the display panel includes the following steps:

S610: Obtain a first luminance compensation value based on an instruction to change a luminance adjustment mode.

S620: Determine a first gamma value based on the first luminance compensation value.

S630: Determine a first data voltage based on the first gamma value.

S640: Drive the first i frames of display images in a current luminance adjustment mode based on the first data voltage.

S650: Obtain a second luminance compensation value when the first i frames in the current luminance adjustment mode end.

S660: Determine a second gamma value based on the second luminance compensation value.

S670: Determine a second data voltage based on the second gamma value.

S680: Drive (i+1)^{th} to (i+n)^{th} frames of display images in the current luminance adjustment mode based on the second data voltage.

On the basis of the above embodiments, obtaining the first luminance compensation value and the second luminance compensation value includes:
obtaining the first luminance compensation value and the second luminance compensation value by using a table lookup method.

The first luminance compensation value and the second luminance compensation value are stored in a drive chip of the display panel. The first luminance compensation value and the second luminance compensation value can be directly obtained by a table lookup method. Specifically, a number of tables is not limited.

On the basis of the above embodiments, before the obtaining a first luminance compensation value based on an instruction to change the luminance adjustment mode, the method further includes:
determining the first luminance compensation value based on at least one gray level and at least one display luminance level.

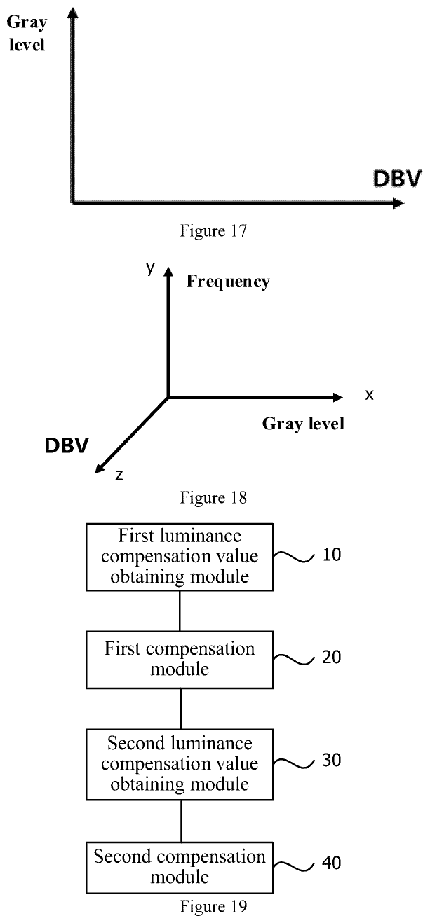

When the luminance adjustment mode changes, the refresh frequency of the display panel may remain unchanged. When the first luminance compensation value is determined, the first luminance compensation value may be determined simply based on the gray level and the display luminance level, thereby reducing the occupied space of the first luminance compensation value, and further reducing the costs of the display panel. As an example, when the display panel switches from the normal display mode to the local high-brightness mode, the refresh frequency of the local high-brightness mode may be a fixed refresh frequency. In this way, the refresh frequency parameter may not be taken into account when determining the first luminance compensation value, thereby reducing the occupied space of the first luminance compensation value. FIG. 17 is a schematic diagram of parameters of a first luminance compensation value according to an embodiment of the present disclosure. In the figure, a horizontal coordinate represents a display luminance level (DBV), and a vertical coordinate represents a gray level. As shown in FIG. 17, the first luminance compensation value may be determined based on the gray level and the display luminance level.

On the basis of the above embodiments, the determining the first luminance compensation value based on at least one gray level and at least one display luminance level includes:
determining the first luminance compensation value based on the gray level, the display luminance level, and a refresh frequency.

When the first luminance compensation value is determined, the first luminance compensation value may be further determined based on the refresh frequency, so as to improve the accuracy of the first luminance compensation value.

On the basis of the above embodiments, before the obtaining a first luminance compensation value based on an instruction to change the luminance adjustment mode, the method further includes:
determining the second luminance compensation value based on a refresh frequency, at least one gray level, and at least one display luminance level.

When displaying images normally, the display panel can display the images at a variety of refresh frequencies. In this case, the second luminance compensation value may be determined based on the refresh frequency, the gray level, and the display luminance level, thereby ensuring the compensation accuracy of the second luminance compensation value and improving the brightness uniformity of the display panel. As an example, FIG. 18 is a schematic diagram of parameters of a second luminance compensation value according to an embodiment of the present disclosure. In the figure, a x-coordinate represents a gray level, a y-coordinate represents a refresh frequency, and a z-coordinate represents a display luminance level (DBV). As shown in FIG. 18, the first luminance compensation value may be determined based on the refresh frequency, the gray level, and the display luminance level.

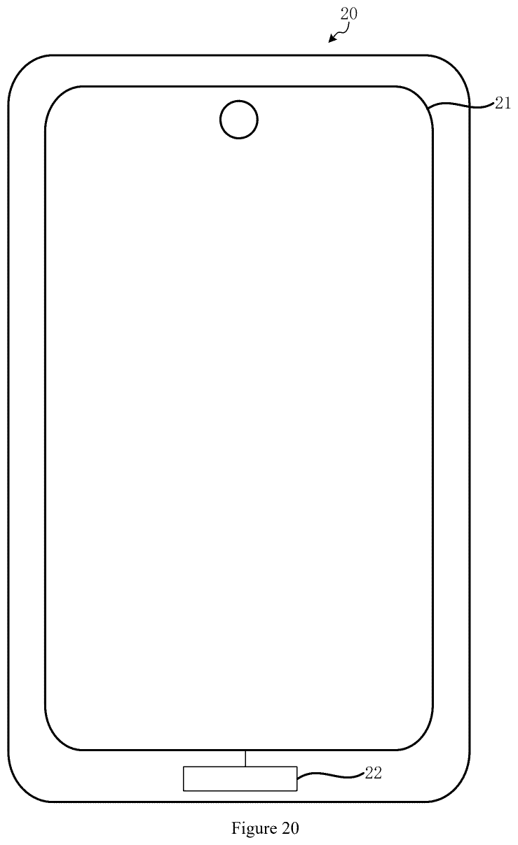

An embodiment of the present disclosure further provides a luminance compensation apparatus for a display panel. A luminance adjustment mode of the display panel includes a pulse width modulation mode. FIG. 19 is a schematic diagram of a structure of a luminance compensation apparatus for a display panel according to an embodiment of the present disclosure. As shown in FIG. 19, the luminance compensation apparatus for the display panel includes:
a first luminance compensation value obtaining module 10 configured to obtain a first luminance compensation value based on an instruction to change the luminance adjustment mode;
a first compensation module 20 configured to compensate luminances of the first i frames of display images in a current luminance adjustment mode to a target luminance based on the first luminance compensation value, where i is an integer greater than or equal to 1;
a second luminance compensation value obtaining module 30 configured to obtain a second luminance compensation value when the first i frames in the current luminance adjustment mode end; and
a second compensation module 40 configured to compensate luminances of (i+1)^{th} to (i+n)^{th} frames of display images in the current luminance adjustment mode to the target luminance based on the second luminance compensation value. Here, n is an integer greater than 1, and the (i+n)^{th} frame of display image is the last frame of display image in the current luminance adjustment mode.

In one embodiment, the first luminance compensation value obtaining module obtains the first luminance compensation value based on the instruction to change the luminance adjustment mode. The first compensation module compensates the luminances of the first i frames of display panels in the current luminance adjustment mode, thereby alleviating the flicker phenomenon of the display panel and improving the display effect of the display panel. In addition, the second compensation module compensates the luminances of the (i+1)^{th} to (i+n)^{th} frames of display panels in the current luminance adjustment mode by using the second luminance compensation value of the display panel in the normal display mode, thereby ensuring brightness uniformity of the display panel, reducing the additionally set luminance compensation value, lowering the performance requirement on the drive chip of the display panel, and reducing the costs of the display panel.

On the basis of the above embodiments, when the display mode of the display panel further includes a local high-brightness mode, the luminance compensation apparatus for the display panel further includes:
a first obtaining module configured to obtain, when the display mode of the display panel enters or exits the local high-brightness mode, the instruction to change the luminance adjustment mode.

On the basis of the above embodiments, the first luminance compensation value includes a first entry luminance compensation value when the display mode of the display panel enters the local high-brightness mode. The first compensation module includes:

a first decreasing unit configured to decrease the luminances of the first i frames of display images in the current luminance adjustment mode to the target luminance based on the first entry luminance compensation value.

In one embodiment, the current luminance adjustment mode is the local high-brightness mode.

In one embodiment, i is less than or equal to 5.

In one embodiment, i is less than or equal to 3.

In one embodiment, i is equal to 1.

On the basis of the above embodiments, the first luminance compensation value includes a first exit luminance compensation value when the display mode of the display panel exits the local high-brightness mode. The first compensation module includes: a first increasing unit configured to: increase the luminances of the first i frames of display images in the current luminance adjustment mode to the target luminance based on the first exit luminance compensation value.

In one embodiment, the current luminance adjustment mode is a normal display mode.

In one embodiment, i is less than or equal to 5.

In one embodiment, i is less than or equal to 3.

In one embodiment, i is equal to 1.

On the basis of the above embodiments, a number of frames of display images with luminances compensated based on the first luminance compensation value when the display mode of the display panel enters the local high-brightness mode is the same as a number of frames of display images with luminances compensated based on the first luminance compensation value when the display mode of the display panel exits the local high-brightness mode.

On the basis of the above embodiments, the luminance adjustment mode further includes a voltage modulation mode. the luminance compensation apparatus for the display panel further includes:
a second obtaining module configured to obtain, when the voltage modulation mode and the pulse width modulation mode are switched to each other, the instruction to change the luminance adjustment mode.

On the basis of the above embodiments, when the luminance adjustment mode is switched from the voltage modulation mode to the pulse width modulation mode, the first luminance compensation value includes a first switching luminance compensation value. The first compensation module includes:
a second increasing unit configured to increase the luminances of the first i frames of display images in the current luminance adjustment mode to the target luminance based on the first switching luminance compensation value.

In one embodiment, the current luminance adjustment mode is the pulse width modulation mode.

In one embodiment, i is less than or equal to 5.

In one embodiment, i is less than or equal to 3.

In one embodiment, i is equal to 1.

On the basis of the above embodiments, when the luminance adjustment mode is switched from the pulse width modulation mode to the voltage modulation mode, the first luminance compensation value includes a second switching luminance compensation value. The first compensation module includes:
a second decreasing unit configured to: decrease the luminances of the first i frames of display images in the current luminance adjustment mode to the target luminance based on the second switching luminance compensation value.

In one embodiment, the current luminance adjustment mode is the voltage modulation mode.

In one embodiment, i is less than or equal to 5.

In one embodiment, i is less than or equal to 3.

In one embodiment, i is equal to 1.

On the basis of the above embodiments, a number of frames of display images with luminances compensated based on the first luminance compensation value when the luminance adjustment mode is switched from the voltage modulation mode to the pulse width modulation mode is the same as a number of frames of display images with luminances compensated based on the first luminance compensation value when the luminance adjustment mode is switched from the pulse width modulation mode to the voltage modulation mode.

On the basis of the above embodiments, the first compensation module includes: a first luminance determining unit configured to compensate the luminances of the first i frames of display images in the current luminance adjustment mode to a first luminance based on the first luminance compensation value; and a target luminance determining unit configured to determine, when a difference between the first luminance and the target luminance is less than a first threshold, that the first luminance is the target luminance.

On the basis of the above embodiments, the luminance compensation apparatus for the display panel further includes:

an adjustment module configured to adjust the first luminance compensation value when the difference between the first luminance and the target luminance is greater than or equal to the first threshold.

On the basis of the above embodiments, the adjustment module includes:
a first adjustment unit configured to adjust the first luminance compensation value when the first luminance is greater than the target luminance, so as to decrease the first luminance; and
a second adjustment unit configured to adjust the first luminance compensation value when the first luminance is less than the target luminance, so as to increase the first luminance.

On the basis of the above embodiments, at least one of: the first compensation module and the second compensation module includes:
a gamma value determining unit configured to determine a gamma value based on a luminance compensation value, where the luminance compensation value includes the first luminance compensation value or the second luminance compensation value; a data voltage determining unit configured to determine a data voltage based on the gamma value; and
a drive unit configured to drive, based on the data voltage, the display panel to display the display images.

On the basis of the above embodiments, the first luminance compensation value obtaining module and the second luminance compensation value obtaining module are specifically configured to obtain the first luminance compensation value and the second luminance compensation value by using a table lookup method.

On the basis of the above embodiments, the luminance compensation apparatus for the display panel further includes:
a first determining module configured to determine the first luminance compensation value based on at least one gray level and at least one display luminance level.

On the basis of the above embodiments, the luminance compensation apparatus for the display panel further includes:
a second determining module configured to determine the second luminance compensation value based on a refresh frequency, at least one gray level, and at least one display luminance level.

An embodiment of the present disclosure further provides a display apparatus. FIG. 20 is a schematic diagram of a structure of a display apparatus according to an embodiment of the present disclosure. As shown in FIG. 20, the display apparatus 20 includes a display panel 21 and the luminance compensation apparatus 22 for the display panel provided in any embodiment of the present disclosure. The luminance compensation apparatus 22 for the display panel is connected to the display panel 21, and the luminance compensation apparatus 22 for the display panel is configured to compensate at least one luminance of at least one display image of the display panel 21 in the current luminance adjustment mode to the target luminance based on the instruction to change the luminance adjustment mode.

The display apparatus 20 includes the luminance compensation apparatus 22 for the display panel provided in any embodiment of the present disclosure, and therefore, exhibits the same beneficial effects as the luminance compensation apparatus 20 for the display panel provided in any embodiment of the present disclosure, which will not be repeated here.

It is to be noted that the above descriptions are merely preferred embodiments of the present disclosure and the technical principles employed. Therefore, although the present disclosure has been described in detail through the above embodiments, the present disclosure is not limited to the above embodiments, and may further include more other equivalent embodiments without departing from the concept of the present disclosure. The scope of the present disclosure is subject to the appended claims.

1. A luminance compensation method for a display panel, wherein a luminance adjustment mode of the display panel comprises a pulse width modulation mode; and the luminance compensation method for the display panel comprises:
obtaining a first luminance compensation value based on an instruction to change the luminance adjustment mode;
compensating luminances of the first i frames of display images in a current luminance adjustment mode to a target luminance based on the first luminance compensation value, wherein i is an integer greater than or equal to 1;
obtaining a second luminance compensation value when the first i frames in the current luminance adjustment mode end; and
compensating luminances of (i+1)^{th} to (i+n)^{th} frames of display images in the current luminance adjustment mode to the target luminance based on the second luminance compensation value, wherein n is an integer greater than 1, and the (i+n)^{th} frame of display image is the last frame of display image in the current luminance adjustment mode.

2. The luminance compensation method for the display panel according to claim 1, wherein a display mode of the display panel comprises a local high-brightness mode; and the luminance compensation method for the display panel further comprises:
obtaining, when the display mode of the display panel enters or exits the local high-brightness mode, the instruction to change the luminance adjustment mode.

3. The luminance compensation method for the display panel according to claim 2, wherein the first luminance compensation value comprises a first entry luminance compensation value when the display mode of the display panel enters the local high-brightness mode; and the compensating luminances of the first i frames of display images in a current luminance adjustment mode to a target luminance based on the first luminance compensation value comprises:
decreasing the luminances of the first i frames of display images in the current luminance adjustment mode to the target luminance based on the first entry luminance compensation value, wherein
the current luminance adjustment mode is the local high-brightness mode.

4. The luminance compensation method for the display panel according to claim 2, wherein the first luminance compensation value comprises a first exit luminance compensation value when the display mode of the display panel exits the local high-brightness mode; and the compensating luminances of the first i frames of display images in a current luminance adjustment mode to a target luminance based on the first luminance compensation value comprises:
increasing the luminances of the first i frames of display images in the current luminance adjustment mode to the target luminance based on the first exit luminance compensation value, wherein
the current luminance adjustment mode is a normal display mode.

5. The luminance compensation method for the display panel according to claim 2, wherein a number of frames of display images with luminances compensated based on the first luminance compensation value when the display mode of the display panel enters the local high-brightness mode is the same as a number of frames of display images with luminances compensated based on the first luminance compensation value when the display mode of the display panel exits the local high-brightness mode.

6. The luminance compensation method for the display panel according to claim 1, wherein the luminance adjustment mode further comprises a voltage modulation mode; and the luminance compensation method for the display panel further comprises:
obtaining, when the voltage modulation mode and the pulse width modulation mode are switched to each other, the instruction to change the luminance adjustment mode.

7. The luminance compensation method for the display panel according to claim 6, wherein when the luminance adjustment mode is switched from the voltage modulation mode to the pulse width modulation mode, the first luminance compensation value comprises a first switching luminance compensation value; and the compensating luminances of the first i frames of display images in a current luminance adjustment mode to a target luminance based on the first luminance compensation value comprises:
increasing the luminances of the first i frames of display images in the current luminance adjustment mode to the target luminance based on the first switching luminance compensation value, wherein
the current luminance adjustment mode is the pulse width modulation mode.

8. The luminance compensation method for the display panel according to claim 6, wherein when the luminance adjustment mode is switched from the pulse width modulation mode to the voltage modulation mode, the first luminance compensation value comprises a second switching luminance compensation value; and the compensating luminances of the first i frames of display images in a current luminance adjustment mode to a target luminance based on the first luminance compensation value comprises:
decreasing the luminances of the first i frames of display images in the current luminance adjustment mode to the target luminance based on the second switching luminance compensation value, wherein
the current luminance adjustment mode is the voltage modulation mode.

9. The luminance compensation method for the display panel according to claim 6, wherein a number of frames of display images with luminances compensated based on the first luminance compensation value when the luminance adjustment mode is switched from the voltage modulation mode to the pulse width modulation mode is the same as a number of frames of display images with luminances compensated based on the first luminance compensation value when the luminance adjustment mode is switched from the pulse width modulation mode to the voltage modulation mode.

10. The luminance compensation method for the display panel according to claim 1, wherein the compensating luminances of the first i frames of display images in a current luminance adjustment mode to a target luminance based on the first luminance compensation value comprises:
compensating the luminances of the first i frames of display images in the current luminance adjustment mode to a first luminance based on the first luminance compensation value; and
determining, when a difference between the first luminance and the target luminance is less than a first threshold, that the first luminance is the target luminance.

11. The luminance compensation method for the display panel according to claim 10, wherein after the compensating the luminances of the first i frames of display images in the current luminance adjustment mode to a first luminance based on the first luminance compensation value, the method further comprises:
adjusting the first luminance compensation value when the difference between the first luminance and the target luminance is greater than or equal to the first threshold.

12. The luminance compensation method for the display panel according to claim 11, wherein the adjusting the first luminance compensation value when the difference between the first luminance and the target luminance is greater than or equal to the first threshold comprises:
adjusting the first luminance compensation value when the first luminance is greater than the target luminance, so as to decrease the first luminance; and
adjusting the first luminance compensation value when the first luminance is less than the target luminance, so as to increase the first luminance.

13. The luminance compensation method for the display panel according to claim 1, wherein compensating the luminances of the display images to the target luminance based on the first luminance compensation value or the second luminance compensation value comprises:
determining a gamma value based on a luminance compensation value, wherein the luminance compensation value comprises the first luminance compensation value or the second luminance compensation value;
determining a data voltage based on the gamma value; and
driving, based on the data voltage, the display panel to display the display images.

14. The luminance compensation method for the display panel according to claim 1, wherein obtaining the first luminance compensation value and the second luminance compensation value comprises:
obtaining the first luminance compensation value and the second luminance compensation value by using a table lookup method.

15. The luminance compensation method for the display panel according to claim 1, wherein before the obtaining a first luminance compensation value based on an instruction to change the luminance adjustment mode, the method further comprises:
determining the first luminance compensation value based on at least one gray level and at least one display luminance level.

16. The luminance compensation method for the display panel according to claim 15, wherein the determining the first luminance compensation value based on at least one gray level and at least one display luminance level comprises:
determining the first luminance compensation value based on the at least one gray level, the at least one display luminance level, and a refresh frequency.

17. The luminance compensation method for the display panel according to claim 1, wherein before the obtaining a first luminance compensation value based on an instruction to change the luminance adjustment mode, the method further comprises:
determining the second luminance compensation value based on a refresh frequency, at least one gray level, and at least one display luminance level.

18. A luminance compensation apparatus for a display panel, wherein a luminance adjustment mode of the display panel comprises a pulse width modulation mode; and the luminance compensation apparatus for the display panel comprises:
a first luminance compensation value obtaining module configured to obtain a first luminance compensation value based on an instruction to change the luminance adjustment mode;
a first compensation module configured to compensate luminances of the first i frames of display images in a current luminance adjustment mode to a target luminance based on the first luminance compensation value, wherein i is an integer greater than or equal to 1;
a second luminance compensation value obtaining module configured to obtain a second luminance compensation value when the first i frames in the current luminance adjustment mode end; and
a second compensation module configured to compensate luminances of (i+1)^{th} to (i+n)^{th} frames of display images in the current luminance adjustment mode to the target luminance based on the second luminance compensation value, wherein n is an integer greater than 1, and the (i+n)^{th} frame of display image is the last frame of display image in the current luminance adjustment mode.

19. The luminance compensation apparatus for the display panel according to claim 18, further comprising:
a first luminance compensation value determining module configured to determine the first luminance compensation value based on at least one gray level and at least one display luminance level.

20. A display apparatus, comprising:
a display panel and a luminance compensation apparatus for a display panel, wherein a luminance adjustment mode of the display panel comprises a pulse width modulation mode; and the luminance compensation apparatus for the display panel comprises:
a first luminance compensation value obtaining module configured to obtain a first luminance compensation value based on an instruction to change the luminance adjustment mode;
a first compensation module configured to compensate luminances of the first i frames of display images in a current luminance adjustment mode to a target luminance based on the first luminance compensation value, wherein i is an integer greater than or equal to 1;
a second luminance compensation value obtaining module configured to obtain a second luminance compensation value when the first i frames in the current luminance adjustment mode end; and
a second compensation module configured to compensate luminances of (i+1)^{th} to (i+n)^{th} frames of display images in the current luminance adjustment mode to the target luminance based on the second luminance compensation value, wherein n is an integer greater than 1, and the (i+n)^{th} frame of display image is the last frame of display image in the current luminance adjustment mode,
wherein the luminance compensation apparatus for the display panel is connected to the display panel, and is configured to compensate at least one luminance of at least one display image of the display panel in the current luminance adjustment mode to the target luminance based on the instruction to change the luminance adjustment mode.
